(19) United States
(12) Patent Application Publication
(10) Pub. No.: US 2023/0212381 A1
(43) Pub. Date: Jul. 6, 2023

(54) Resin Composition, and Aqueous Coating Fluid and Multilayer Structure Each Comprising Same

(71) Applicant: KURARAY CO., LTD., Okayama (JP)

(72) Inventors: Kenichi Kobayashi, Kurashiki-shi, Okayama (JP); Hiroyuki Konishi, Kurashiki-shi, Okayama (JP); Akihisa Watajima, Kurashiki-shi, Okayama (JP); Makoto Adachi, Kurashiki-shi, Okayama (JP)

(73) Assignee: KURARAY CO., LTD., Okayama (JP)

(21) Appl. No.: 17/928,040

(22) PCT Filed: May 28, 2021
(86) PCT No.: PCT/JP2021/020390

§ 371 Date: Nov. 28, 2022

(30) Foreign Application Priority Data
May 29, 2020 (JP) 2020-093840

(51) Int. Cl. C08L 29/04; C08K 3/34; C09D 129/04

(52) U.S. Cl. CPC C08L 29/04; C08K 3/346; C09D 129/04; C08L 2203/16

(57) ABSTRACT

A resin composition comprises: a modified vinyl alcohol-based polymer (A) containing from 1 to 20 mol % of a structural unit represented by a formula (1) below; and a layered inorganic compound (B). Such a resin composition is excellent in water vapor barrier properties, recyclability, and productivity during coating.

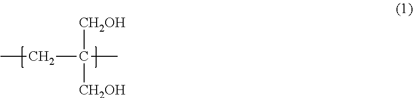

### TECHNICAL FIELD

The present invention relates to a resin composition with gas barrier properties to be preferably used as a film for packaging applications, particularly for food packaging applications. The present invention also relates to a water-based coating liquid and a multilayer structure, both using the resin composition.

### BACKGROUND ART

Oxygen gas barrier films and packaging materials using the same are well known. Although aluminum (hereinafter, abbreviated as “Al”) foil is one of the materials with oxygen gas barrier properties, Al alone has low pinhole strength and cannot be used except special cases, resulting in often being used as an intermediate layer of a laminated film. Such a laminated film has good oxygen gas barrier properties while having disadvantages, such as invisibility of the contents due to the non-transparency and difficulty in recycling the film.

Other known oxygen gas barrier films include single-component films of polyvinylidene chloride (hereinafter, abbreviated as “PVDC”) and PVDC-coated films. In particular, the PVDC-coated films are used as lamination base films to be used for food packaging materials requiring barrier properties against oxygen gas and water vapor. PVDC has little moisture absorbency and maintains good gas barrier properties even at high humidity and is thus used to coat various base materials. Examples of the base material to be used include films of biaxially oriented polypropylene (OPP), biaxially oriented nylon (ON), biaxially oriented polyethylene terephthalate (OPET), cellophane, and the like. The laminated films have gas barrier properties and are used for packaging various foods, such as dry provisions and moist foods. However, there is a growing trend of not using these packaging materials because it is difficult to recycle multilayer films containing a PVDC layer by melt molding when these packaging materials after use are disposed of from households as general waste.

Proposals as a gas barrier film capable of being recycled include those produced by forming an evaporated thin film using metal oxide on a substrate film. For example, Patent Document 1 discloses a packaging material for moist foods using a gas barrier film having a plastic base provided with a thin film mainly of silicon oxide on at least one surface, the thin film having a specific gravity from 1.80 to 2.20. This film, however, has a problem of cracking when being folded, tending to impair the barrier properties.

As oxygen gas barrier films, polyvinyl alcohol (hereinafter, abbreviated as “PVA”) films are also well known. PVA films have very good oxygen gas barrier properties in a state of absorbing less moisture, whereas the PVA films are not sufficient in water vapor barrier properties due to the moisture absorbency and thus tend to have limited applications. Proposals are made to improve the moisture absorbency of PVA, including resin compositions containing: an ethylene-vinyl alcohol copolymer obtained by copolymerizing ethylene; and an inorganic layered compound, and the like. For example, Patent Document 2 discloses a resin composition containing: a saponification product of an ethylene-vinyl ester copolymer with an ethylene content from 1 to 15 mol %; a saponification product of an ethylene-vinyl ester copolymer with an ethylene content from 15 to 70 mol %; and an inorganic layered compound. However, the amount of the inorganic layered compound has to be increased to cause the composition to exhibit high gas barrier properties, causing problems of insufficient strength of a film comprising the composition and the like.

Patent Document 3 discloses a resin composition containing: a water-soluble polyvinyl alcohol-based resin having a 1,2-diol structural unit in the main chain; and a water-swellable layered inorganic compound. According to the description, the resin composition is excellent in the gas barrier properties and is made into a water-based coating liquid forming smaller bubbles and thus having good defoaming properties, and when being made into a multilayer structure, the resin composition is excellent in adhesion to an adjacent thermoplastic resin. There is, however, no description on the water vapor barrier properties, which is the problem of the PVA films. Patent Document 4 discloses a modified vinyl alcohol-based polymer containing: a vinyl alcohol unit; an ethylene unit; and a structural unit having a primary hydroxy group in a side chain. However, the polymer is not intended to improve the performance as a coating agent for oxygen and water vapor gas barrier applications.

### PRIOR ART DOCUMENTS

### Patent Documents

Patent Document 1: JP 06-344492 A
Patent Document 2: JP 2001-114966 A
Patent Document 3: JP 2007-161795 A
Patent Document 4: JP 2015-34262 A

### SUMMARY OF THE INVENTION

### Problems to be Solved by the Invention

The present invention has been made to solve the above problems and it is an object thereof to provide a resin composition excellent in water vapor barrier properties, recyclability, and productivity during coating. Particularly among them, it is an object thereof to inhibit the decrease in water vapor barrier properties due to moisture absorption, which is the problem of films using a vinyl alcohol-based polymer.

### Means for Solving the Problems

The above problems are solved by providing a resin composition comprising: a modified vinyl alcohol-based polymer (A) containing from 1 to 20 mol % of a structural unit represented by a formula (1) below; and a layered inorganic compound (B).

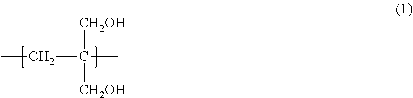

In this situation, it is preferable that the modified vinyl alcohol-based polymer (A) contains from 1 to 20 mol % of an ethylene unit. It is also preferable that a mass ratio (B/A) of the layered inorganic compound (B) to the modified vinyl alcohol-based polymer (A) is from 0.1/100 to 100/100. It is also preferable that the layered inorganic compound (B) is swelling mica.

It is preferable that the resin composition has a water vapor transmission rate of 200 g·30 μm/m²·day or less. It is also preferable that the resin composition further comprises water.

A water-based coating liquid, comprising the above resin composition is a preferred embodiment of the present invention. A multilayer structure, having at least one layer comprising the above resin composition is another preferred embodiment of the present invention.

### Effects of the Invention

The resin composition of the present invention is excellent in water vapor barrier properties, recyclability, and productivity during coating. The water-based coating liquid comprising the resin composition has high viscosity stability and a long pot life, and is thus excellent in productivity during coating. Particularly, the resin composition has excellent water vapor barrier properties even in a high humidity environment. Moreover, the resin composition is excellent in water solubility and is thus allowed to be readily removed from, for example, a shaped article such as a multilayer structure, achieving excellent recyclability as well.

### MODES FOR CARRYING OUT THE INVENTION

The resin composition of the present invention comprises: a modified vinyl alcohol-based polymer (A) containing from 1 to 20 mol % of a structural unit represented by a formula (1) below; and a layered inorganic compound (B).

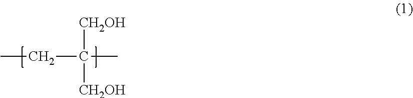

The modified vinyl alcohol-based polymer (A) contains a vinyl alcohol unit and the structural unit represented by the formula (1) above. The structural unit represented by the formula (1) above is contained to reduce the crystallinity of the modified vinyl alcohol-based polymer (A), and thus to cause improvement in water solubility, and when used in an aqueous solution, viscosity stability. Meanwhile, a decrease in the crystallinity usually causes a decrease in barrier properties of the vinyl alcohol-based polymer. However, the modified vinyl alcohol-based polymer (A) surprisingly maintains high barrier properties, and in particular, maintains high water vapor barrier properties even at high humidity. These effects are considered to be caused by the low mobility because the structural unit represented by the formula (1) above contains one quaternary carbon constituting the main chain of the modified vinyl alcohol-based polymer (A) and also by the high hydrogen bonding strength derived from the two hydroxy groups in the monomer unit. The resin composition of the present invention containing the modified vinyl alcohol-based polymer (A) with such a property and the layered inorganic compound (B) has excellent water solubility, and excellent viscosity stability when made into an aqueous solution, in addition to high gas barrier properties, particularly high water vapor barrier properties even at high humidity.

The structural unit represented by the formula (1) above may be formed by a method comprising copolymerization of an unsaturated monomer having a 1,3-diester structure followed by saponification or a method comprising copolymerization of 2-methylene-1,3-propanediol.

The content of the structural unit represented by the formula (1) above is from 1 to 20 mol % in the modified vinyl alcohol-based polymer (A). The content of 1 mol % or more causes further improvement in water solubility of the modified vinyl alcohol-based polymer (A) and the resin composition using the same, and when being an aqueous solution, viscosity stability of them. The content is preferably 1.5 mol % or more, more preferably 2 mol % or more, even more preferably 2.5 mol % or more, particularly preferably 3 mol % or more, and most preferably 4 mol % or more. Meanwhile, a content of more than 20 mol % causes a marked decrease in the rate of polymerization, tending to cause difficulty in industrial synthesis. The content is preferably 15 mol % or less and more preferably 10 mol % or less.

The vinyl alcohol unit is usually formed by saponifying a vinyl ester unit in the polymer. The vinyl alcohol unit gives water solubility to the modified vinyl alcohol-based polymer (A).

It is preferable that the modified vinyl alcohol-based polymer (A) contains an ethylene unit. The ethylene unit is contained to further improve gas barrier properties of the resin composition to be obtained, and particularly water vapor barrier properties at high humidity.

When the modified vinyl alcohol-based polymer (A) contains the ethylene unit, the content is preferably from 1 to 20 mol %. The content of 1 mol % or more causes further improvement in gas barrier properties, particularly water vapor barrier properties at high humidity, of the modified vinyl alcohol-based polymer (A) and the resin composition using the same. The ethylene unit content is more preferably 2 mol % or more, even more preferably 4 mol % or more, particularly preferably 6 mol % or more, and most preferably 10 mol % or more. Meanwhile, the content of 20 mol % or less causes a further increase in water solubility of the resin composition to be obtained and productivity during coating. The content is more preferably 18 mol % or less and even more preferably 16 mol % or less.

The modified vinyl alcohol-based polymer (A) of the present invention preferably has a number-average degree of polymerization Pn from 200 to 950. Pn of 200 or more causes improvement in strength of a film obtained from the modified vinyl alcohol-based polymer of the present invention. Pn is more preferably 300 or more and even more preferably 350 or more. Meanwhile, Pn of 950 or less causes a solution of the modified vinyl alcohol-based polymer not to have too high viscosity, and thus causes further improvement in solution stability. Pn is more preferably 800 or less and even more preferably 600 or less. The number-average degree of polymerization Pn and a weight-average degree of polymerization Pw of the modified vinyl alcohol-based polymer (A) are measured by gel permeation chromatography (GPC). Specifically, Pn is obtained by the method described in Examples. The measurement is performed at 40° C. using monodisperse polymethyl methacrylate (PMMA) as a standard and hexafluoroisopropanol (HFIP) added with 20 millimoles/liter of sodium trifluoroacetate as a mobile phase. It is possible to control Pn by, for example, the amount of a solvent or addition of a chain transfer agent when the polymer is prepared by radical polymerization.

The modified vinyl alcohol-based polymer (A) of the present invention preferably has a weight-average degree of polymerization Pw from 300 to 2000. Pw of 350 or more causes improvement in strength of a film obtained using the resin composition of the present invention. Pw is more preferably 400 or more and even more preferably 450 or more. Meanwhile, Pw of 2000 or less causes further improvement in viscosity stability when the resin composition is an aqueous solution. Pw is more preferably 950 or less. It is possible to control Pw by, for example, the amount of a solvent or addition of a chain transfer agent when the polymer is prepared by radical polymerization.

The modified vinyl alcohol-based polymer (A) preferably has a degree of saponification, but not particularly limited to, from 80 to 99.99 mol %. A degree of saponification of less than 80 mol % causes a risk of not having sufficient water vapor barrier properties. The degree of saponification is more preferably 90 mol % or more and even more preferably 95 mol % or more. Meanwhile, it is sometimes difficult to industrially obtain such a polymer (A) having a degree of saponification of more than 99.99 mol %. The degree of saponification is more preferably 99.95 mol % or less and even more preferably 99.90 mol % or less.

The degree of saponification in the present invention is defined by DS in the following equation, and specifically, calculated from the results of NMR measurement.

DS=[(Number of Moles of Hydroxy Group)/(Total Number of Moles of Hydroxy Group and Ester Group Capable of Being Converted to Hydroxy Group by Saponification)]×100

In the above equation, the ester group is contained in the vinyl ester unit, the structural unit having a 1,3-diester structure, and the structural unit having one hydroxy group and one ester group, and the hydroxy group is contained in the vinyl alcohol unit, the structural unit represented by the formula (1) above, and the structural unit having one hydroxy group and one ester group. The structural unit represented by the formula (1) above thus contains two hydroxy groups. As described later, the structural unit having one hydroxy group and one ester group may be formed together with the structural unit represented by the formula (1) above by hydrolysis of the structural unit having a 1,3-diester structure.

The method for producing the modified vinyl alcohol-based polymer (A) is not particularly limited. Examples of the method include a method comprising: radical polymerization of the vinyl ester represented by a formula (2) below, the unsaturated monomer having a 1,3-diester structure represented by a formula (3) below, and ethylene as needed to obtain a modified vinyl ester-based polymer; followed by saponification.

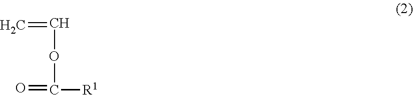

In the formula (2), R¹ denotes a hydrogen atom or an alkyl group having a carbon number from 1 to 9. The alkyl group preferably has a carbon number from 1 to 4. Examples of the vinyl ester represented by the formula (2) include vinyl formate, vinyl acetate, vinyl propionate, vinyl butyrate, vinyl isobutyrate, vinyl pivalate, vinyl versatate, vinyl caproate, and the like. From an economic perspective, vinyl acetate is particularly preferred.

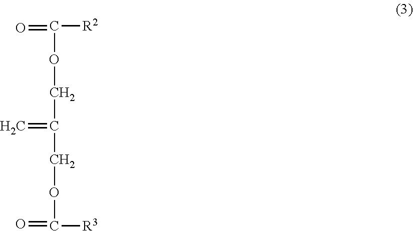

In the formula (3), each of R² and R³ independently of each other denotes a hydrogen atom or an alkyl group having a carbon number from 1 to 9. The alkyl group preferably has a carbon number from 1 to 4. Examples of the unsaturated monomer represented by the formula (3) include 1,3-diacetoxy-2-methylenepropane (DAMP), 1,3-dipropionyloxy-2-methylenepropane, 1,3-dibutyronyloxy-2-methylenepropane, and the like. Among them, 1,3-diacetoxy-2-methylenepropane (DAMP) is readily produced and thus preferably used. If a monosubstituted olefin, such as 3,4-diacetoxy-1-butene (DAB) described in Patent Document 3, is used as a comonomer, DAB and the like tend to remain in the reaction system in the polymerization with vinyl acetate due to the matter of the monomer reactivity ratio. There is thus a problem such that DAB and the like are mixed in a finished product and the monomer recovery system and a problem such that the chain transfer causes difficulty in control of the degree of polymerization. In contrast, the polymerization of 1,3-diacetoxy methylenepropane (DAMP), which is a disubstituted olefin, with vinyl acetate has an advantage such that DAMP is likely to be preferentially consumed due to the monomer reactivity ratio and thus is less likely to affect the monomer recovery system and an advantage such that the chain transfer is suppressed and thus the degree of polymerization is readily controlled.

The style of polymerization for production of the modified vinyl ester-based polymer by copolymerizing the vinyl ester represented by the formula (2) above, the unsaturated monomer having a 1,3-diester structure represented by the formula (3) above, and ethylene as needed may be any of batch polymerization, semi-batch polymerization, continuous polymerization, and semi-continuous polymerization. In addition, as the method of polymerization, it is possible to employ a known method, such as a bulk polymerization method, a solution polymerization method, a suspension polymerization method, and an emulsion polymerization method. A bulk polymerization method or a solution polymerization method is usually employed, in which polymerization proceeds without solvent or in a solvent, such as an alcohol. An emulsion polymerization method is an option for producing such a modified vinyl ester-based polymer with a high degree of polymerization.

Although a solvent used in a solution polymerization method is not particularly limited, an alcohol is used preferably, and lower alcohols, such as methanol, ethanol, and propanol, for example, are more preferably used. The amount of solvent to be used in the polymerization reaction liquid may be selected considering the intended viscosity-average degree of polymerization of the modified vinyl alcohol-based polymer and chain transfer of the solvent, and a mass ratio of the solvent to the total monomers contained in the reaction liquid (solvent/total monomers) is selected in the range from 0.01 to 10, preferably the range from 0.05 to 3.

A polymerization initiator used for the copolymerization is selected in accordance with the method of polymerization from known polymerization initiators, for example, an azo initiator, a peroxide initiator, and a redox initiator. Examples of the azo initiator include 2,2-azobisisobutyronitrile, 2,2-azobis(2,4-dimethylvaleronitrile), and 2,2-azobis(4-methoxy-2,4-dimethylvaleronitrile). Examples of the peroxide initiator include: percarbonate compounds, such as diisopropyl peroxydicarbonate, di-2-ethylhexyl peroxydicarbonate, and diethoxyethyl peroxydicarbonate; perester compounds, such as t-butyl peroxyneodecanoate, α-cumyl peroxyneodecanoate, and acetyl peroxide; acetylcyclohexylsulfonyl peroxide; 2,4,4-trimethylpentyl-2-peroxyphenoxyacetate; and the like. Potassium persulfate, ammonium persulfate, hydrogen peroxide, and the like may be used in combination with the above initiators. The redox initiator is a polymerization initiator obtained by combining, for example, the above peroxide initiators with a reducing agent, such as sodium hydrogen sulfite, sodium hydrogen carbonate, tartaric acid, L-ascorbic acid, and rongalite. The amount of polymerization initiator to be used is different depending on the polymerization catalyst and thus is not determined unconditionally, and the amount is controlled in accordance with the rate of polymerization. The amount of polymerization initiator to be used based on the vinyl ester represented by the formula (2) above is preferably from 0.01 to 0.2 mol % and more preferably from 0.02 to 0.15 mol %. The polymerization temperature is, but not particularly limited to, appropriately from room temperature to 150° C. approximately and preferably not less than 40° C. and not more than the boiling point of the solvent to be used.

The copolymerization may be performed in the presence of a chain transfer agent as long as the effects of the present invention are not inhibited. Examples of the chain transfer agent include: aldehydes, such as acetaldehyde and propionaldehyde; ketones, such as acetone and methylethylketone; mercaptans, such as 2-hydroxyethanethiol; and phosphinates, such as sodium phosphinate monohydrate. Among all, aldehydes and ketones are used preferably. Although the amount of the chain transfer agent added to the polymerization reaction liquid is determined in accordance with the chain transfer constant of the chain transfer agent and the intended degree of polymerization of the modified vinyl ester-based polymer, it is preferably from 0.1 to 10 parts by mass based on 100 parts by mass of the vinyl ester represented by the formula (2) above in general.

It is possible to obtain the modified vinyl alcohol-based polymer (A) by saponifying the modified vinyl ester-based polymer thus obtained. In this situation, the vinyl ester unit derived from the vinyl ester represented by the formula (2) in the polymer is converted to a vinyl alcohol unit. In addition, the structural unit having a 1,3-diester structure derived from the unsaturated monomer represented by the formula (3) is also hydrolyzed at the same time to be converted to the structural unit represented by the formula (1) above having a 1,3-diol structure. In such a manner, it is possible to hydrolyze different kinds of ester group by one saponification reaction at the same time. The modified vinyl alcohol-based polymer (A) may contain unhydrolyzed vinyl ester units, unhydrolyzed structural units having a 1,3-diester structure, and structural units having one hydroxy group and one ester group where only the one ester group is hydrolyzed in the structural unit having a 1,3-diester structure.

It is possible to employ a known method for saponifying the modified vinyl ester-based polymer. The saponification reaction is usually carried out in an alcohol or hydrous alcohol solution. The alcohol preferably used in this situation is a lower alcohol, such as methanol and ethanol, and particularly preferably methanol. The alcohol or hydrous alcohol used for the saponification reaction may contain another solvent, as long as the solvent is 40 mass % or less of its mass, such as acetone, methyl acetate, ethyl acetate, and benzene. The catalyst used for the saponification is, for example, alkali metal hydroxides, such as potassium hydroxide and sodium hydroxide; alkaline catalysts, such as sodium methylate; and acid catalysts, such as mineral acid. The temperature to carry out the saponification is, but not limited to, preferably in the range from 20° C. to 120° C. In the case that gelatinous products precipitate as the saponification proceeds, it is possible to obtain the modified vinyl alcohol-based polymer (A) by grinding the products and then washing and drying them.

The modified vinyl alcohol-based polymer (A) may contain a structural unit (z) derived from another ethylenic unsaturated monomer that is copolymerizable with ethylene, the vinyl ester represented by the formula (2) above, and the unsaturated monomer represented by the formula (3) above as long as the effects of the present invention are not inhibited. Examples of such an ethylenic unsaturated monomer include: α-olefins, such as propylene, n-butene, isobutylene, and 1-hexene; acrylic acid and salts thereof; unsaturated monomers containing an acrylic ester group; methacrylic acid and salts thereof; unsaturated monomers containing a methacrylic ester group; acrylamide, N-methylacrylamide, N-ethylacrylamide, N,N-dimethylacrylamide, diacetoneacrylamide, acrylamide propanesulfonic acid and salts thereof, and acrylamidopropyl dimethylamine and salts thereof (e.g., quaternary salts); methacrylamide, N-methylmethacrylamide, N-ethylmethacrylamide, methacrylamide propanesulfonic acid and salts thereof, and methacrylamidopropyl dimethylamine and salts thereof (e.g., quaternary salts); vinyl ethers, such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; vinyl cyanides, such as acrylonitrile and methacrylonitrile; vinyl halides, such as vinyl chloride and vinyl fluoride; vinylidene halides, such as vinylidene chloride and vinylidene fluoride; allyl compounds, such as allyl acetate, 2,3-diacetoxy-1-allyloxypropane, and allyl chloride; unsaturated dicarboxylic acids, such as maleic acid, itaconic acid, and fumaric acid, and salts thereof and esters thereof; vinylsilane compounds, such as vinyltrimethoxysilane; and isopropenyl acetates. In the modified vinyl alcohol-based polymer (A), the content of the structural unit (z) derived from another ethylenic unsaturated monomer is preferably 10 mol % or less, more preferably 5 mol % or less, and even more preferably 2 mol % or less.

The modified vinyl alcohol-based polymer (A) may contain a carboxyl group, a sulfonic acid group, an amino group, or a salt thereof in a side chain or a molecular end as long as the performance of the present invention is not impaired. The amount of modification is usually from 0.05 to 10 mol % based on the total monomer units of the modified vinyl alcohol-based polymer (A).

The layered inorganic compound (B) is an inorganic sheet compound with a layered structure, which includes those developing a sheet structure by a process, such as swelling, cleavage, and delamination. The layered inorganic compound (B) is preferably an inorganic compound in which the unit crystal layers are laminated with each other to form a layered structure, and such a compound may contain a cation or an anion between the unit crystal layers. The layered inorganic compound (B) preferably has swelling properties. The layered inorganic compound with swelling properties in this context means a layered inorganic compound that is added to a solvent, such as water and an alcohol, to be swollen for cleavage or dispersion. Specific examples of the layered inorganic compound (B) include: inorganic layered silicates, such as mica, montmorillonite, kaolinite, dickite, nakhlite, halloysite, antigorite, chrysotile, pyrophyllite, beidellite, nontronite, saponite, sauconite, stevensite, hectorite, tetrasilicic mica, sodium taeniolite, muscovite, margarite, talc, vermiculite, phlogopite, xanthophyllite, and chlorite; graphenes, such as graphene, graphene oxide, and reduced graphene oxide; and the like. Among them, inorganic layered silicates and graphenes are preferred, and inorganic layered silicates are more preferred. The inorganic layered silicates are preferably clay minerals, and among them, more preferably clay minerals of the mica group, the smectite group, and the vermiculite group and particularly preferably those of the mica group and the smectite group. Examples of the mica group include mica and examples of the smectite group include montmorillonite, beidellite, nontronite, saponite, sauconite, stevensite, and hectorite. Among them, mica and montmorillonite are preferred, and mica is more preferred. Two or more kinds may be used as the inorganic layered compound.

The aspect ratio of the layered inorganic compound (B) is not particularly limited, as long as the effects of the present invention are not impaired, and is preferably from 20 to 200,000. The aspect ratio is more preferably 50 or more and even more preferably 70 or more. Meanwhile, the aspect ratio is more preferably 100,000 or less and even more preferably 50,000 or less. The layered inorganic compound (B) has an aspect ratio (Z) defined by Z=L/a. In this equation, L denotes the average particle size of the layered inorganic compound and a denotes the unit thickness of the layered inorganic compound, that is, the thickness of each unit crystal layer in the inorganic layered compound, and is obtained by X-ray diffraction. The average particle size of the layered inorganic compound (B) is not particularly limited, as long as the effects of the present invention are not impaired, and is preferably from 20 nm to 200 μm. The average particle size is more preferably 50 nm or more and even more preferably 100 nm or more. Meanwhile, the average particle size is more preferably 100 μm or less and even more preferably 50 μm or less. The average particle size of the layered inorganic compound (B) is a particle size (volume-based median size) obtained by diffraction scattering by dispersing the layered inorganic compound in a liquid medium, such as water, and is measured with a laser diffraction scattering particle size distribution analyzer.

The layered inorganic compound (B) by itself has an interplanar spacing not particularly limited, as long as the effects of the present invention are not impaired, and which is preferably from 0.1 nm to 100 nm. The interplanar spacing is preferably 50 nm or less and more preferably 10 nm or less. The interplanar spacing refers to the distance d obtained based on the Bragg equation (nλ=2d sin θ, n=1, 2, 3, . . . ) from an angle θ corresponding to a low angle peak among the peaks obtained by X-ray diffraction.

The layered inorganic compound (B) in the resin composition of the present invention preferably has an interplanar spacing wider than the interplanar spacing of the layered inorganic compound (B) by itself. The layered inorganic compound (B) with an expanded interplanar spacing by swelling, cleavage, or dispersion in the solvent is mixed with the modified vinyl alcohol-based polymer (A) or its solution to cause the modified vinyl alcohol-based polymer (A) to enter between the unit crystal layers of the layered inorganic compound (B), thereby expanding the interplanar spacing. The expansion of the interplanar spacing is confirmed by observing a shift of the angle θ corresponding to the low angle peak derived from the layered inorganic compound (B) among the peaks obtained by X-ray diffraction of the resin composition to the lower angle side or by observing no low angle peaks derived from the layered inorganic compound (B).

The entrance of the modified vinyl alcohol-based polymer (A) between the unit crystal layers of the layered inorganic compound (B) causes improvement in water vapor barrier properties of the resin composition of the present invention. This is because the transmitting gas is not capable of transmitting the unit crystal layers of the layered inorganic compound (B) and thus moves around the unit crystal layers and then diffuses, leading to a longer effective length to transmit the resin composition (e.g., a film). In the layered inorganic compound (B), each unit crystal layer has a high aspect ratio, that is, a high ratio of the width to the thickness and thus cause efficient improvement in water vapor barrier properties compared with spherical and fibrous inorganic compounds.

In the resin composition of the present invention, it is preferable that a mass ratio (B/A) of the layered inorganic compound (B) to the modified vinyl alcohol-based polymer (A) is from 0.1/100 to 100/100. The mass ratio (B/A) of 0.1/100 or more causes further improvement in gas barrier properties, particularly water vapor barrier properties at high humidity. The mass ratio (B/A) is more preferably 1/100 or more, even more preferably 3/100 or more, and particularly preferably 7/100 or more. From the perspective of obtaining a resin composition with particularly high water vapor barrier properties, the mass ratio (B/A) is preferably 15/100 or more, more preferably 30/100 or more, and even more preferably 50/100 or more. Meanwhile, the mass ratio (B/A) of 100/100 or less causes a resin composition to be obtained to maintain the mechanical properties. The mass ratio (B/A) is more preferably 90/100 or less, even more preferably 80/100 or less, and particularly preferably 70/100 or less.

The resin composition of the present invention preferably has a water vapor transmission rate of 200 g·30 μm/m²·day or less. Such a resin composition with a low water vapor transmission rate is excellent in water vapor barrier properties and is thus preferably used as a packaging film for foods and the like. The water vapor transmission rate is more preferably 140 g·30 μm/m²·day or less, even more preferably 100 g·30 μm/m²·day or less, particularly preferably 65 g·30 μm/m²·day or less, and most preferably 55 g·30 μm/m²·day or less. The water vapor transmission rate is obtained by measuring a film made from the resin composition, and specifically, obtained by the method described in Examples.

The resin composition of the present invention, when dried and then immersed in water, preferably has a degree of elution in water of 50 mass % or more. Such a resin composition with a high degree of elution in water, when used for a multilayer structure described later, is readily removed from the multilayer structure with hot water and the like. It thus allows the resin composition to be separated from the components other than the resin composition for recovery and reuse, leading to production of a multilayer structure excellent in recyclability. The degree of elution is obtained by the method described in Examples.

The form of the resin composition of the present invention is not particularly limited, and may be a solid or may be a liquid or a slurry in which the modified vinyl alcohol-based polymer (A) and the layered inorganic compound (B) are dissolved or dispersed.

In the resin composition of the present invention, the total amount of the modified vinyl alcohol-based polymer (A) and the layered inorganic compound (B) is preferably 5 mass % or more, more preferably 10 mass % or more, even more preferably 50 mass % or more, particularly preferably 60 mass % or more, and most preferably 80 mass % or more. Meanwhile, from the perspective of the handleability as a water-based coating liquid comprising the resin composition of the present invention described later, the total amount is preferably 50 mass % or less.

In the resin composition of the present invention, the total amount of the modified vinyl alcohol-based polymer (A) and the layered inorganic compound (B) is preferably 50 mass % or more based on the total solid contents, more preferably 70 mass % or more, even more preferably 80 mass % or more, and particularly preferably 90 mass % or more.

It is preferable that the resin composition of the present invention further comprises water. The modified vinyl alcohol-based polymer (A) is highly water soluble, and thus such a resin composition containing water is preferably used as a water-based coating liquid and the like. The resin composition is more preferably a dispersion in which the layered inorganic compound (B) is dispersed in water containing the modified vinyl alcohol-based polymer (A) dissolved therein.

The resin composition of the present invention may contain an aliphatic alcohol having a carbon number from 1 to 4 together with water. Although the aliphatic alcohol is not particularly limited as long as it is water soluble, preferably used examples include methanol, ethanol, isopropyl alcohol, n-propyl alcohol, and the like. From the perspective of further increasing the solubility of the modified vinyl alcohol-based polymer (A), the ratio of the aliphatic alcohol to the total of water and the aliphatic alcohol in the resin composition is preferably 50 mass % or less, more preferably 40 mass % or less, even more preferably 20 mass % or less, and particularly preferably 10 mass % or less. Meanwhile, when the resin composition contains the aliphatic alcohol together with water, the ratio of the aliphatic alcohol to the total of water and the aliphatic alcohol in the resin composition is preferably 0.5 mass % or more, more preferably 1 mass % or more, and even more preferably 2 mass % or more.

The resin composition of the present invention may contain a crosslinking agent. This causes improvement in water resistance of the resin composition. Examples of the crosslinking agent include epoxy compounds, isocyanate compounds, aldehyde compounds, silica compounds, aluminum compounds, boron compounds, zirconium compounds, and the like, and preferably used examples include silica compounds, such as colloidal silica and alkyl silicate, and zirconium compounds. When the resin composition contains such a crosslinking agent, the content is not particularly limited, as long as the effects of the present invention are not impaired, and is usually from 1 to 60 parts by mass based on 100 parts by mass of the modified polyvinyl alcohol-based polymer (A). A content of the crosslinking agent of more than 60 parts by mass sometimes affects the water vapor barrier properties.

The resin composition of the present invention may contain additives other than the modified vinyl alcohol-based polymer (A), the layered inorganic compound (B), water, the aliphatic alcohol, and the crosslinking agent. Examples of the other additives include: resins, such as polyvinyl alcohols and ethylene-vinyl alcohol copolymers, containing no structural units represented by the formula (1) above; inorganic salts; organic salts; solvents; ultraviolet absorbers; antioxidants; antistatic agents; plasticizers; mildewcides; preservatives; surfactants; leveling agents; and the like. Two or more kinds of them may be used together.

Examples of the method for producing the resin composition of the present invention include, but not particularly limited to:

(1) a method comprising mixing an aqueous solution of the modified vinyl alcohol-based polymer (A) with a water dispersion of the layered inorganic compound (B);

(2) a method comprising mixing powder of the modified vinyl alcohol-based polymer (A) with a water dispersion of the layered inorganic compound (B) and then dissolving the modified vinyl alcohol-based polymer (A);

(3) a method comprising mixing an aqueous solution of the modified vinyl alcohol-based polymer (A) with powder of the layered inorganic compound (B) to disperse the layered inorganic compound (B);

(4) a method comprising mixing powder of the modified vinyl alcohol-based polymer (A), powder of the layered inorganic compound (B), and water, followed by dissolution of the modified vinyl alcohol-based polymer (A) and dispersion of the layered inorganic compound (B);

(5) a method comprising coating a substrate with the resin composition containing water obtained by any method from (1) to (4) above and then drying;

(6) a method comprising melt kneading powder of the modified vinyl alcohol-based polymer (A) and powder of the layered inorganic compound (B);

(7) a method comprising melt kneading powder of the modified vinyl alcohol-based polymer (A) and a water dispersion of the layered inorganic compound (B); and the like. It should be noted that, when the layered inorganic compound (B) is water swellable, known stirring and dispersion devices may be used for swelling in water.

The resin composition of the present invention may further contain water, and examples of preferred embodiments of the present invention include a water-based coating liquid comprising the resin composition containing water. The water-based coating liquid has high viscosity stability because an increase in viscosity with time is inhibited, and thus the coating liquid is excellent in productivity during coating. A film to be formed from the coating liquid has excellent gas barrier properties, particularly high water vapor barrier properties even in the case of absorbing moisture.

The water-based coating liquid during coating is preferably at temperatures from 20° C. to 80° C. As the coating method, a known method is preferably used, such as gravure roll coating, reverse gravure coating, reverse roll coating, and wire bar coating. Such a method allows production of shaped articles comprising the resin composition of the present invention. Examples of the shape of the shaped articles include, but not particularly limited to, films and sheets.

A multilayer structure having at least one layer comprising the resin composition of the present invention (hereinafter, may be abbreviated as a “resin composition layer”) is also a preferred embodiment of the present invention. The multilayer structure has gas barrier properties, and in particular, the resin composition has high water vapor barrier properties even in the case of absorbing moisture. The resin composition of the present invention is highly water soluble, and thus removal of the resin composition layer by dissolution from the multilayer structure allows the layers other than the resin composition layer to be readily recovered for reuse. Accordingly, the multilayer structure is also excellent in recyclability.

Examples of such a layer other than the resin composition layer contained in the multilayer structure include a layer made from a resin other than polyvinyl alcohols and ethylene-vinyl alcohol copolymers. Examples of such another resin include polyolefin, polyester, polyamide, and the like. As these resins, conventionally known ones are preferably used and there is no limitation in the resin structure, such as syndiotactic and isotactic.

In the multilayer structure, the resin composition layer has a thickness of, but not particularly limited to, usually from 0.1 to 30 μm.

The method for producing the multilayer structure is not particularly limited, and examples of the method include a method comprising applying the water-based coating liquid of the present invention on a base film made from the above-described resin other than the polyvinyl alcohols and the ethylene-vinyl alcohol copolymers.

Between the layer comprising the resin composition and another layer described above, a known anchor coating layer may be provided.

After applying the water-based coating liquid on the base film, the coated film may be freely subjected to orientation, heat treatment, and the like. The orientation ratio, the heat treatment temperature, and the like depend on the base film and may be in the known ranges.

After the resin composition layer is formed on the base film, a heat seal resin layer may be further formed on the resin composition layer. The heat seal resin layer is usually formed by extrusion lamination or dry lamination. As the heat seal resin, known heat seal resins are used including: polyethylenes, such as high-density polyethylene (HDPE), low-density polyethylene (LDPE), and linear low-density polyethylene (LLDPE); polypropylene; ethylene-vinyl acetate copolymers; ethylene/α-olefin random copolymers; ionomers; and the like.

### EXAMPLES

The present invention will be described more in detail below by way of Examples while the present invention is not at all limited by these Examples. It should be noted that “%” and “parts” in Examples and Comparative Examples respectively denote “mass %” and “parts by mass” unless otherwise specified.

¹H-NMR

The primary structure [content (mol %) of each monomer unit and degree of saponification (mol %)] of the modified vinyl alcohol-based polymer was determined by 500 MHz ¹H-NMR. As the solvent for the polymer for the ¹H-NMR measurement, DMSO-d6 was used.

### Number-Average Degree of Polymerization and Weight-Average Degree of Polymerization

The number-average molecular weight (Mn) and the weight-average molecular weight (Mw) of the polymer were measured using a size exclusion high performance liquid chromatography system “HLC-8320 GPC” manufactured by Tosoh Corp. The measurement conditions were as follows.

Column: two HFIP-based columns “GMHHR-H(S)” manufactured by Tosoh Corp., serial connection Standard material: polymethyl methacrylate

Solvent and mobile phase: sodium trifluoroacetate-HFIP solution (concentration of 20 mM)

Flow rate: 0.2 mL/min.

Temperature: 40° C.

Sample solution concentration: 0.1 mass % (filtered through a filter having an opening diameter of 0.45 μm)

Injection amount: 10 μL Detector: RI

The number-average degree of polymerization Pn and the weight-average degree of polymerization Pw of the polymer were obtained by the following equations.

Pn=Mn×100/(28×a+44×b+88×c)

Pw=Mw×100/(28×a+44×b+88×c)

In the above equations, a denotes the ethylene unit content (mol %), b denotes the vinyl alcohol unit content (mol %), and c denotes the content (mol %) of the structural unit represented by the formula (1) above.

### Aspect Ratio of Layered Inorganic Compound (B)

The aspect ratio (Z) of the layered inorganic compound (B) is a value defined by Z=L/a. In this equation, L denotes the average particle size of the layered inorganic compound and a denotes the unit thickness of the layered inorganic compound, that is, the thickness of each unit crystal layer of the layered inorganic compound, and may be obtained by X-ray diffraction. As the value of the unit thickness a of each layered inorganic compound, 20 nm was used for mica, 1 nm for montmorillonite, and 1 nm for graphene oxide.

### Average Particle Size of Layered Inorganic Compound (B)

Calculation of Average Particle Size

The average particle size (volume-based median size (d50)) of the layered inorganic compound was obtained using a laser diffraction scattering particle size distribution analyzer LA-950 (Horiba Ltd.). Specifically, a water dispersion of the layered inorganic compound (B) was diluted with deionized water to have a light transmittance of 90% or more using a batch cell for measurement.

### Water Vapor Barrier Properties

The measurement was performed using films with a thickness of 30 μm obtained in Examples and Comparative Examples. With reference to JIS Z 0208: 1976 of Testing Methods for Determination of the Water Vapor Transmission Rate of Moisture-Proof Packaging Materials (Dish Method), the amount of water vapor passing through the film per unit time under the conditions of 40° C. and 90% RH was obtained by measuring the mass of water vapor adsorbed on calcium chloride in the dish to calculate a water vapor transmission rate Ps (g·30 μm/m²·day). The measurement was performed per predetermined time period and the values in the stable phase were employed (average value of n=2). A lower value of the water vapor transmission rate Ps indicates superior water vapor barrier properties.

### Water Vapor Barrier Property Improvement Ratio (Ps/Pp)

A film with a thickness of 30 μm was obtained in the same manner as that in each Example or Comparative Example except for not adding the layered inorganic compound and then a water vapor transmission rate Pp (g·30 μm/m²·day) was measured using the above method. The ratio of the water vapor transmission rate Ps of the film containing the layered inorganic compound to the water vapor transmission rate Pp of the film containing no layered inorganic compounds was defined as the water vapor barrier property improvement ratio (Ps/Pp). A lower value of the water vapor barrier property improvement ratio (Ps/Pp) indicates improvement in water vapor barrier properties.

### Degree of Elution

The measurement was performed using films with a thickness of 100 μm obtained in Examples and Comparative Examples. In a room conditioned at 20° C., each film was cut into a size of 50 mm in length, 50 mm in width, and 0.1 mm in thickness to measure the film mass. After 25 ml of deionized water (100 times the sample amount) was poured into a glass container, the film sample was immersed therein. The film sample was taken out 5 minutes after the immersion and dried in a hot air dryer at 105° C. for 300 minutes, followed by measurement of the mass of the film after drying. The amount of film elution was then obtained in accordance with the following equation and evaluated in A through C.

Degree of Elution=(Film Mass−Mass After Drying)/(Film Mass)×100(%)

A: the degree of elution was 50 mass % or more

B: the degree of elution was 25 mass % or more and less than 50 mass %

C: the degree of elution was less than 25 mass %

### Pot Life

The coating liquids with a solid content concentration of 20 mass % obtained in Examples were left at 20° C. and the viscosity was measured per day to define the number of days until the viscosity reached 10000 mPa sec or more as the pot life. The viscosity was measured with LVDV-II+P (manufactured by Brookfield Engineering Lab.).

### Folding Endurance Test

The measurement was performed using films with a thickness of 100 μm obtained in Examples and Comparative Examples. Each film (10 cm in length, 10 cm in width) was folded into two at the center to put a crease. The film was unfolded, rotated 90 degrees, and folded into two at the center to put a crease. When the film was not broken by being folded into two, filter paper was placed under the film and oil based ink was applied in the cross folding area of the film to check whether the ink struck through.

A: the film was not broken and the oil based ink did not strike through.

B: the film was broken or the oil based ink struck through.

### Synthesis Example 1

Production of Polymer 1

To a 5 L pressure reaction vessel provided with a stirrer, a nitrogen inlet, an ethylene inlet, an initiator addition port, and a solution feed port, 1.2 kg of vinyl acetate, 1.4 kg of methanol, and 0.059 kg of 1,3-diacetoxy-2-methylenepropane (DAMP) were charged, and the temperature was raised to 60° C., followed by nitrogen bubbling for 30 minutes to purge inside the system with nitrogen.

Separately, a solution with a concentration of 42 g/L in which DAMP was dissolved in methanol was prepared as a feed solution, and nitrogen gas bubbling was carried out. Further separately, an initiator solution with a concentration of 20 g/L in which 2,2-azobis(isobutyronitrile) was dissolved in methanol was prepared as a radical polymerization initiator, and nitrogen gas bubbling was carried out for nitrogen purge.

Subsequently, ethylene was introduced into the pressure reaction vessel to have a reaction vessel pressure of 0.8 MPa. After the temperature in the pressure reaction vessel was adjusted to 60° C., 120 mL of the above initiator solution was poured to initiate polymerization. During the polymerization, the polymerization temperature was maintained at 60° C. and the solution of DAMP in methanol was fed to carry out the polymerization. After the rate of polymerization was confirmed to be 40%, the polymerization was terminated by cooling. The amount of the solution of DAMP in methanol (concentration of 42 g/L) fed until the polymerization was terminated was 550 mL in total.

After removing ethylene by opening the pressure reaction vessel, nitrogen gas was bubbled to completely remove ethylene. Subsequently, the unreacted vinyl acetate monomer was removed under reduced pressure to provide a solution of a modified ethylene-vinyl acetate copolymer (hereinafter, may be referred to as a “modified PVAc”) in methanol. Then, methanol was added to this solution, and to 486 parts by mass of the solution of the modified PVAc in methanol thus prepared (the modified PVAc was 100 parts by mass in the solution), 14.0 parts by mass of a solution of sodium hydroxide in methanol (concentration of 10.0%) was added to carry out saponification at 40° C. (the saponification solution had a concentration of the modified PVAc of 20%, the molar ratio of sodium hydroxide to the vinyl acetate unit in the modified PVAc was 0.2). The saponification proceeded by grinding the gelled system approximately 1 minute after the addition of alkali with a grinder and leaving it at 40° C. for 1 hour, and then 1000 g of methyl acetate was added to neutralize the residual alkali.

After the end of the neutralization was confirmed using a phenolphthalein indicator, the white solid saponification product obtained by filtering was added with a mixed solvent of 900 g of methanol and 100 g of water and was left at room temperature for 3 hours and washed. The above washing operation was repeated three times, followed by centrifugal deliquoring to obtain a saponification product. The saponification product was left in a dryer at 70° C. for 2 days to obtain a dried modified vinyl alcohol-based polymer (Polymer 1).

The modified vinyl alcohol-based polymer (Polymer 1) thus obtained had a number-average degree of polymerization Pn of 700, a weight-average degree of polymerization Pw of 1350, a degree of saponification of 99.0 mol %, an ethylene unit content of 10 mol %, and a content of the structural unit represented by the formula (1) above of 6.6 mol %.

### Synthesis Examples 2 Through 6

Production of Polymers 2 Through 6

Respective modified vinyl alcohol-based polymers (Polymers 2 through 6) were produced by the same method as that in Synthesis Example 1 except for changing the polymerization conditions, such as the amounts of vinyl acetate and methanol to be charged, the ethylene pressure during the polymerization, and the amount of the comonomer used for the polymerization to be added, and the saponification conditions, such as the molar ratio of sodium hydroxide to the vinyl acetate unit during the saponification, as shown in Table 1.

TABLE 1

| | | Vinyl | | DAMP | | Ethylene | |
|---|---|---|---|---|---|---|---|
| | | Acetate | Methanol | Initial | Feed | Pressure | |
| | Polymer | (kg) | (kg) | Charge (kg) | Amount (mL) | (Mpa) | NaOH ¹⁾ |
| Synthesis | Polymer 1 | 1.2 | 1.4 | 0.059 | 550 | 0.8 | 0.2 |
| Example 1 | | | | | | | |
| Synthesis | Polymer 2 | 1.2 | 1.4 | 0.045 | 400 | 1.1 | 0.2 |
| Example 2 | | | | | | | |
| Synthesis | Polymer 3 | 1.2 | 2.3 | — | — | 0.6 | 0.2 |
| Example 3 | | | | | | | |
| Synthesis | Polymer 4 | 1.2 | 2.6 | — | — | 0.3 | 0.2 |
| Example 4 | | | | | | | |
| Synthesis | Polymer 5 | 1.2 | 2.3 | — | — | — | 0.2 |
| Example 5 | | | | | | | |
| Synthesis | Polymer 6 | 1.2 | 1.5 | 0.051 | 460 | — | 0.2 |
| Example 6 | | | | | | | |

¹⁾ Molar ratio of sodium hydroxide to vinyl acetate unit in modified PVAc

### Example 1

Coating liquids and films were prepared to have a mica content of 60 parts by mass based on 100 parts by mass of the modified vinyl alcohol-based polymer (A) (Polymer 1).

Specifically, 20 g of the modified vinyl alcohol-based polymer (A) (Polymer 1) and 80 g of deionized water were mixed and heated to 95° C. for 1 hour with a hot stirrer, followed by cooling to room temperature to obtain a 20 mass % aqueous solution of Polymer 1.

A mixture of 101 g of a water dispersion of swelling mica (SOMASIF MEB-3 produced by Katakura & Co-op Agri Corp., solid content concentration of 8.1 mass %, aspect ratio of 80, average particle size of 1.6 μm) and 48.1 g of deionized water was prepared and subjected to a dispersion process at 10,000 rpm for 15 minutes with CLEARMIX (CLM-08S manufactured by M Technique Co., Ltd.) to obtain a water dispersion with a mica content of 5.5 mass % (mica/water dispersion).

A mixture of 12 g of the aqueous solution of Polymer 1, 26.2 g of the mica/water dispersion, and 0.2 g of deionized water was prepared and then stirred at 400 rpm for 30 minutes with a hot stirrer to obtain a coating liquid (solid content concentration of 10 mass %) of the layered inorganic compound (B) (swelling mica) dispersed in the deionized water in which the modified vinyl alcohol-based polymer (A) (Polymer 1) was dissolved.

A PET film was coated with the coating liquid thus prepared using an applicator (manufactured by YOSHIMITSU) and then dried at 60° C. for 1 hour. The dried coating was then separated from the PET film to obtain a self-supporting film with a thickness of 30 μm. The results of evaluating the film properties are shown in Table 2. The water vapor transmission rate Ps was 50 g·30 μm/m²·day. The water vapor barrier property improvement ratio (Ps/Pp) was 0.143 (=50/350) and the containment of mica caused improvement in the water vapor barrier properties of the resin composition.

In addition, the coating liquid thus prepared (solid content concentration of 10 mass %) was separately formed into a film by casting and dried at room temperature to prepare a 100 μm film for measurement of the degree of elution.

In addition, a coating liquid (solid content concentration of 20 mass %, mass ratio (B/A) of 60/100) was separately prepared, for measurement of the pot life, using the aqueous solution of Polymer 1 and the mica/water dispersion with increased solid content concentrations and using a reduced amount of deionized water added for coating liquid preparation. The results are shown in Table 2.

### Examples 2 through 5, 8 through 11, Comparative Examples 1, 3 through 12

Respective coating liquids (solid content concentration: 10 mass %, 20 mass %) and films (thickness: 30 μm, 100 μm) were produced and evaluated in the same manner as that in Example 1 except for changing the kind of modified vinyl alcohol-based polymer (A) as shown in Table 2 and adjusting the solid content concentrations of the aqueous polymer solution and the mica/water dispersion and the amount of the mica/water dispersion and deionized water to be added as shown in Table 2 (no mica added in Comparative Examples 7 through 12). The results are shown in Table 2. It should be noted that the coating liquid with a solid content concentration of 20 mass % was obtained by, in Comparative Examples 7 through 12, changing the amount of deionized water added for preparation of the coating liquid to 0, and in Examples and the other Comparative Examples, using the aqueous polymer solution and the mica/water dispersion with increased solid content concentrations and also using a reduced amount of deionized water added for preparation of the coating liquid. In addition, in Example 3 and Comparative Example 1, folding endurance test was carried out. The results are shown in Table 2.

### Example 6

A mixture of 5.25 g of montmorillonite (Kunimine Industries Co., Ltd., Kunipia-G, aspect ratio of 300, average particle size of 0.3 μm) with 144 g of deionized water was prepared and subjected to ultrasonication for 3 minutes with an ultrasonic generator and further a dispersion process at 7,500 rpm for 15 minutes with CLEARMIX (CLM-0.8S manufactured by M Technique Co., Ltd.) to obtain a 3.5 mass % water dispersion of montmorillonite. Coating liquids (solid content concentration: 10 mass %, 20 mass %) and films (thickness: 30 μm, 100 μm) were produced and evaluated in the same manner as that in Example 1 except for changing the mica/water dispersion to the montmorillonite/water dispersion and adjusting the amount of the montmorillonite/water dispersion and deionized water to be added as shown in Table 2. It should be noted that the coating liquid with a solid content concentration of 20 mass % was obtained by using the aqueous polymer solution and the montmorillonite/water dispersion with increased solid content concentrations and also using a reduced amount of deionized water added for preparation of the coating liquid. The results are shown in Table 2.

### Example 7

To 5.0 ml of a graphene oxide/water dispersion (solid content concentration of 10 mg/ml, aspect ratio of 5000, average particle size of 5 μm, produced by Tokyo Chemical Industry Co., Ltd.), 85.5 ml of deionized water and 10 g of Polymer 1 powder were added and heated to 95° C. to completely dissolve Polymer 1, followed by cooling to obtain a coating liquid. Films with a thickness of 30 μm and 100 μm were produced and evaluated in the same manner as that in Example 1 except for using the coating liquid thus obtained. In addition, a coating liquid (solid content concentration of 20 mass %) was separately prepared with a reduced amount of deionized water added for preparation of the coating liquid to be used for measurement of the pot life. The results are shown in Table 2.

### Comparative Example 2

Coating liquids (solid content concentration: 10 mass %, 20 mass %) and films (thickness: 30 μm, 100 μm) were produced and evaluated in the same manner as that in Example 6 except for using an unmodified ethylene-vinyl alcohol copolymer shown in Table 2. The results are shown in Table 2.

TABLE 2

| | Modified Vinyl Alcohol-Based Polymer (A) | | | | | | | | | | | | | Evaluation | | | | |
|---|---|---|---|---|---|---|---|---|---|---|---|---|---|---|---|---|---|---|
| | | Structural Unit | | Degree | | | | Coating Liquid with Solid Content Concentration of 10 mass % | | | | | | Water Vapor | | | | |
| | | represented | | of | | | Layered | Aqueous Solution of (A) | | Water Dispersion of (B) | | | | Transmission | | | | |
| | | by | Ethylene | Saponifi- | | | Inorganic | Concentration | Amount to be | Concentration | Amount to | | Mass | Rate Ps | | Degree | Pot | Folding |
| | | Formula (1) | Unit | cation | | | Compound | of (A) | Added | of (B) | be Added | Water | Ratio | g · 30 μm/ | | of | Life | Endurance |
| | Polymer | mol % | mol % | mol % | Pn | Pw | (B) | mass % | g | mass % | g | g | (B/A) | m² · day | Ps/Pp | Elution | day | Test |
| Example 1 | Polymer 1 | 6.6 | 10 | 99.0 | 700 | 1350 | Mica | 20 | 12 | 5.5 | 26.2 | 0.2 | 60/100 | 50 | 0.143 | A | ≥7 | — |
| Example 2 | Polymer 1 | 6.6 | 10 | 99.0 | 700 | 1350 | Mica | 20 | 12 | 5.5 | 17.5 | 4.1 | 40/100 | 60 | 0.171 | A | ≥7 | — |
| Example 3 | Polymer 1 | 6.6 | 10 | 99.0 | 700 | 1350 | Mica | 20 | 12 | 5.5 | 8.7 | 8.1 | 20/100 | 70 | 0.200 | A | ≥7 | A |
| Example 4 | Polymer 1 | 6.6 | 10 | 99.0 | 700 | 1350 | Mica | 20 | 12 | 5.5 | 4.4 | 10.0 | 10/100 | 110 | 0.314 | A | ≥7 | — |
| Example 5 | Polymer 1 | 6.6 | 10 | 99.0 | 700 | 1350 | Mica | 20 | 12 | 5.5 | 2.2 | 11.0 | 5/100 | 170 | 0.486 | A | ≥7 | — |
| Example 6 | Polymer 1 | 6.6 | 10 | 99.0 | 700 | 1350 | Mont- | 20 | 12 | 3.5 | 13.7 | 3.1 | 20/100 | 170 | 0.486 | A | ≥7 | — |
| | | | | | | | morillonite | | | | | | | | | | | |
| Example 7 | Polymer 1 | 6.6 | 10 | 99.0 | 700 | 1350 | Graphene | 100 | 10 | 1 | 5.0 | 85.5 | 0.5/100 | 100 | 0.286 | A | ≥7 | — |
| | | | | | | | Oxide | | | | | | | | | | | |
| Example 8 | Polymer 2 | 5.0 | 14 | 99.0 | 700 | 1200 | Mica | 20 | 12 | 5.5 | 17.5 | 4.1 | 40/100 | 40 | 0.133 | A | ≥7 | — |
| Example 9 | Polymer 2 | 5.0 | 14 | 99.0 | 700 | 1200 | Mica | 20 | 12 | 5.5 | 8.7 | 8.1 | 20/100 | 50 | 0.167 | A | ≥7 | — |
| Example 10 | Polymer 2 | 5.0 | 14 | 99.0 | 700 | 1200 | Mica | 20 | 12 | 5.5 | 4.4 | 10.0 | 10/100 | 70 | 0.233 | A | ≥7 | — |
| Example 11 | Polymer 6 | 5.7 | 0 | 99.0 | 400 | 760 | Mica | 20 | 12 | 5.5 | 8.7 | 8.1 | 20/100 | 90 | 0.129 | A | ≥7 | — |
| Comparative | Polymer 3 | 0.0 | 8 | 98.5 | 450 | 830 | Mica | 20 | 12 | 5.5 | 17.5 | 4.1 | 40/100 | 90 | 0.231 | C | 2 | B |
| Example 1 | | | | | | | | | | | | | | | | | | |
| Comparative | Polymer 3 | 0.0 | 8 | 98.5 | 450 | 830 | Mont- | 20 | 12 | 3.5 | 13.7 | 3.1 | 20/100 | 200 | 0.513 | C | 2 | — |
| Example 2 | | | | | | | morillonite | | | | | | | | | | | |
| Comparative | Polymer 4 | 0.0 | 4 | 98.5 | 450 | 870 | Mica | 20 | 12 | 5.5 | 17.5 | 4.1 | 40/100 | 180 | 0.400 | C | 2 | — |
| Example 3 | | | | | | | | | | | | | | | | | | |
| Comparative | Polymer 4 | 0.0 | 4 | 98.5 | 450 | 870 | Mica | 20 | 12 | 5.5 | 8.7 | 8.1 | 20/100 | 250 | 0.556 | C | 2 | — |
| Example 4 | | | | | | | | | | | | | | | | | | |
| Comparative | Polymer 5 | 0.0 | 0 | 98.5 | 500 | 950 | Mica | 20 | 12 | 5.5 | 17.5 | 4.1 | 40/100 | 200 | 0.364 | C | 1 | — |
| Example 5 | | | | | | | | | | | | | | | | | | |
| Comparative | Polymer 5 | 0.0 | 0 | 98.5 | 500 | 950 | Mica | 20 | 12 | 5.5 | 8.7 | 8.1 | 20/100 | 250 | 0.455 | B | 1 | — |
| Example 6 | | | | | | | | | | | | | | | | | | |
| Comparative | Polymer 1 | 6.6 | 10 | 99.0 | 700 | 1350 | — | 20 | 12 | — | — | 12 | 0/100 | 350 | — | A | ≥7 | — |
| Example 7 | | | | | | | | | | | | | | | | | | |
| Comparative | Polymer 2 | 5.0 | 14 | 99.0 | 700 | 1200 | — | 20 | 12 | — | — | 12 | 0/100 | 300 | — | A | ≥7 | — |
| Example 8 | | | | | | | | | | | | | | | | | | |
| Comparative | Polymer 3 | 0.0 | 8 | 98.5 | 450 | 830 | — | 20 | 12 | — | — | 12 | 0/100 | 390 | — | B | 1 | — |
| Example 9 | | | | | | | | | | | | | | | | | | |
| Comparative | Polymer 4 | 0.0 | 4 | 98.5 | 450 | 870 | — | 20 | 12 | — | — | 12 | 0/100 | 450 | — | B | 2 | — |
| Example 10 | | | | | | | | | | | | | | | | | | |
| Comparative | Polymer 5 | 0.0 | 0 | 98.5 | 500 | 900 | — | 20 | 12 | — | — | 12 | 0/100 | 550 | — | B | 1 | — |
| Example 11 | | | | | | | | | | | | | | | | | | |
| Comparative | Polymer 6 | 5.7 | 0 | 99.0 | 400 | 760 | — | 20 | 12 | — | — | 12 | 0/100 | 700 | — | A | ≥7 | — |
| Example 12 | | | | | | | | | | | | | | | | | | |

As shown in Table 2, the resin composition of the present invention (Examples 1 through 11) using both the modified vinyl alcohol-based polymer (A) containing from 1 to 20 mol % of the structural unit represented by the formula (1) above and the layered inorganic compound (B) had a greatly improved water vapor transmission rate [low water vapor barrier property improvement ratio (Ps/Pp)] and thus had an excellent water vapor transmission rate. In addition, the resin composition (film) of the present invention had a high degree of elution when immersed in deionized water and was thus excellent in water solubility. The coating liquid (resin composition containing deionized water) of the present invention had an inhibited increase in viscosity with time and thus had a long pot life.

Meanwhile, in the cases that the unmodified ethylene-vinyl alcohol copolymer containing no structural units represented by the formula (1) above and having an ethylene unit content of 8 mol % was used as the resin (Comparative Examples 1 and 2), the resin composition (film) had a low degree of elution and insufficient water solubility, and moreover, the coating liquid was gelled on the second day after leaving and thus had a short pot life. In the cases that the unmodified ethylene-vinyl alcohol copolymer containing no structural units represented by the formula (1) above and having an ethylene unit content of 4 mol % (Comparative Examples 3 and 4) and the unmodified polyvinyl alcohol (Comparative Examples 5 and 6) were used as the resin, the resin composition (film) had low water vapor barrier properties and a low degree of elution and thus had insufficient water solubility, and moreover, the coating liquid was gelled on the first or second day after leaving and thus had a short pot life.

In the cases that the coating liquids were prepared using the modified vinyl alcohol-based polymer containing the structural unit represented by the formula (1) above but containing no layered inorganic compounds (Comparative Examples 7, 8, 12), the resulting resin composition (film) had a low transmission rate. In the cases that the aqueous solution containing no layered inorganic compounds and containing only the unmodified ethylene-vinyl alcohol copolymer (Comparative Examples 9 and 10) and the aqueous solution containing only the unmodified polyvinyl alcohol (Comparative Example 11) were used as the coating liquid, the film had a high water vapor transmission rate and thus had low water vapor barrier properties, had a low degree of elution and thus had insufficient water solubility, and moreover, the coating liquid was gelled on the first or second day after leaving and thus had a short pot life and low viscosity stability.

As shown in Table 2, the resin composition of the present invention (Example 3) comprises the layered inorganic compound (B) added to the modified vinyl alcohol-based polymer (A) containing from 1 to 20 mol % of the structural unit represented by the formula (1) above, thereby having an excellent water vapor transmission rate while maintaining the folding endurance.

Meanwhile, in the case that the unmodified ethylene-vinyl alcohol copolymer containing no structural units represented by the formula (1) above was used as the resin (Comparative Example 1), the layered inorganic compound (B) had inferior dispersibility and folding endurance was reduced.

1. A resin composition comprising: a modified vinyl alcohol-based polymer (A) containing from 1 to 20 mol % of a structural unit represented by a formula (1) below; and a layered inorganic compound (B).

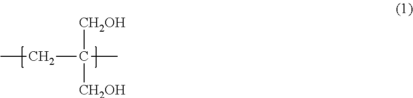

2. The resin composition according to claim 1, wherein the modified vinyl alcohol-based polymer (A) contains from 1 to 20 mol % of an ethylene unit.

3. The resin composition according to claim 1, wherein a mass ratio (B/A) of the layered inorganic compound (B) to the modified vinyl alcohol-based polymer (A) is from 0.1/100 to 100/100.

4. The resin composition according to claim 1, wherein the layered inorganic compound (B) is swelling mica.

5. The resin composition according to claim 1, wherein the resin composition has a water vapor transmission rate of 200 g·30 μm/m²·day or less.

6. The resin composition according to claim 1, further comprising water.

7. A water-based coating liquid, comprising the resin composition according to claim 6.

8. A multilayer structure, having at least one layer comprising the resin composition according to claim 1.
